(19) United States
(12) Patent Application Publication
(10) Pub. No.: US 2008/0200291 A1
(43) Pub. Date: Aug. 21, 2008

(54) Anti-backlash device

(76) Inventors: Raymond Barylski, Port Huron, MI (US); Jason Barylski, Burtchville Twp., MI (US)

Correspondence Address: CHRISTOPHER JOHN RUDY, 209 HURON AVENUE, SUITE 8, PORT HURON, MI, 48060, US

(21) Appl. No.: 12/011,686

(22) Filed: Jan. 29, 2008

Related U.S. Application Data
(60) Provisional application No. 60/898,247, filed on Jan. 30, 2007.

(51) Int. Cl. F16H 7/08

(52) U.S. Cl. 474/101

(57) ABSTRACT

Anti-backlash device for an internal combustion engine, which has a timing chain, includes a body having a stop shoulder to provide a default tension for the chain; and a mounting feature with the body. The device can be part of a kit, and can be mounted in combination with the engine. A method of reducing or avoiding backlash in a timing chain in an internal combustion engine can embrace providing the device and installing it in the engine, optionally further running the engine with the installed device.

This claims benefits under 35 USC 119(e) of U.S. provisional patent application No. 60/898,247 filed on Jan. 30, 2007 A.D. The complete specification of that application, which, of course, includes its drawings, is incorporated herein by reference.

### FIELD AND PURVIEW OF THE INVENTION

This invention concerns a device, kit and method for reducing or avoiding backlash in a timing chain in an internal combustion engine, as well as the device in combination with the engine.

### BACKGROUND TO THE INVENTION

Various internal combustion engines such as those employed in automotive environments have timing chains. A general problem, which particularly concerns the Chrysler 2.7-liter V-6, double overhead cam (DOHC) engine, is that a chain-tensioner, which applies tension to a right hand side timing chain guide and in turn to the long timing chain, can fail, to leave the chain without suitable tension. When that happens, the chain typically slips off its lower drive sprocket before the operator of the vehicle realizes or can react by shutting the engine down, with a common result that timing for the valves and cylinders is lost. Under such a faulty condition, a piston rises in its respective cylinder when its valve is open, thus hitting the valve and causing severe damage to the valve and piston, as well as causing engine failure. The time and expense required to repair or replace the failed engine are significant.

It would be desirable to ameliorate or solve such a problem.

### A FULL DISCLOSURE OF THE INVENTION

In general, the present invention provides an anti-backlash device for an internal combustion engine that has a timing chain, which comprises a body having a stop shoulder to provide a default tension for the chain; and a mounting feature with the body. The device can be part of a kit, and can be mounted in combination with the engine. A method of reducing or avoiding backlash in a timing chain in an internal combustion engine can comprise providing the device and installing it in the engine, optionally further running the engine with the installed device.

The invention is useful as an engine failure prophylactic.

Significantly, by the invention, the art is advanced in kind, and the aforementioned problem with its frequently devastating and expensive consequences can be ameliorated if not essentially overcome. The invention is simple, and economical to make and install. It can be retrofit to existing engines, in a particular embodiment, to a twin-cam engine such as the Chrysler 2.7-liter V-6 DOHC engine, i.e., those small Chrysler-Mitsubishi 2.7L V-6 power-horses many people love. The invention can be adapted for fitting into new engines with tight timing chains as well as used engines with loose used or tight new replacement chains.

Numerous further advantages attend the invention.

The drawings form part of the specification hereof. With respect to the drawings, which are not necessarily drawn to scale, the following is briefly noted:

FIG. 1 is a top view of an embodiment of an anti-backlash device of the invention.

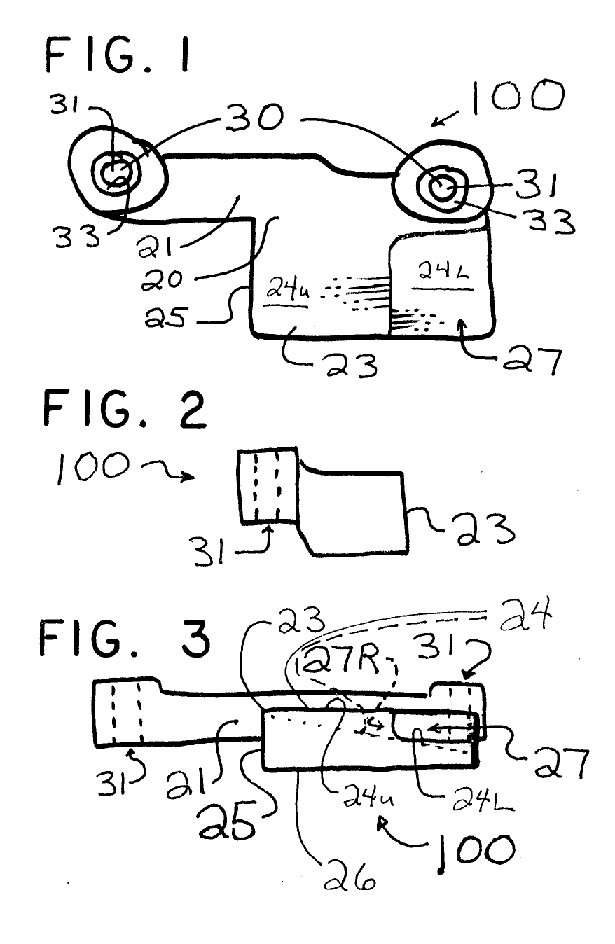

FIG. 2 is a left side plan view of the embodiment of FIG. 1 (left-right orientation from the rear of the engine).

FIG. 3 is a rear plan view of the embodiment of FIG. 1.

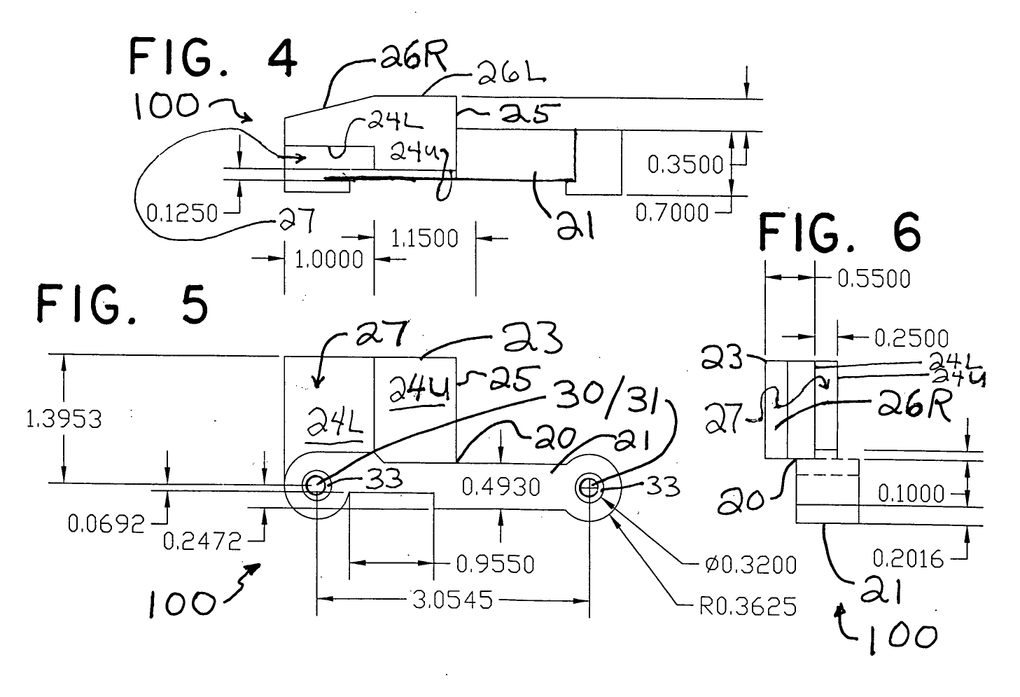

FIG. 4 is a front view of another embodiment of an anti-backlash device of the invention.

FIG. 5 is a top view of the embodiment of FIG. 4.

FIG. 6 is a right side view of the embodiment of FIG. 4.

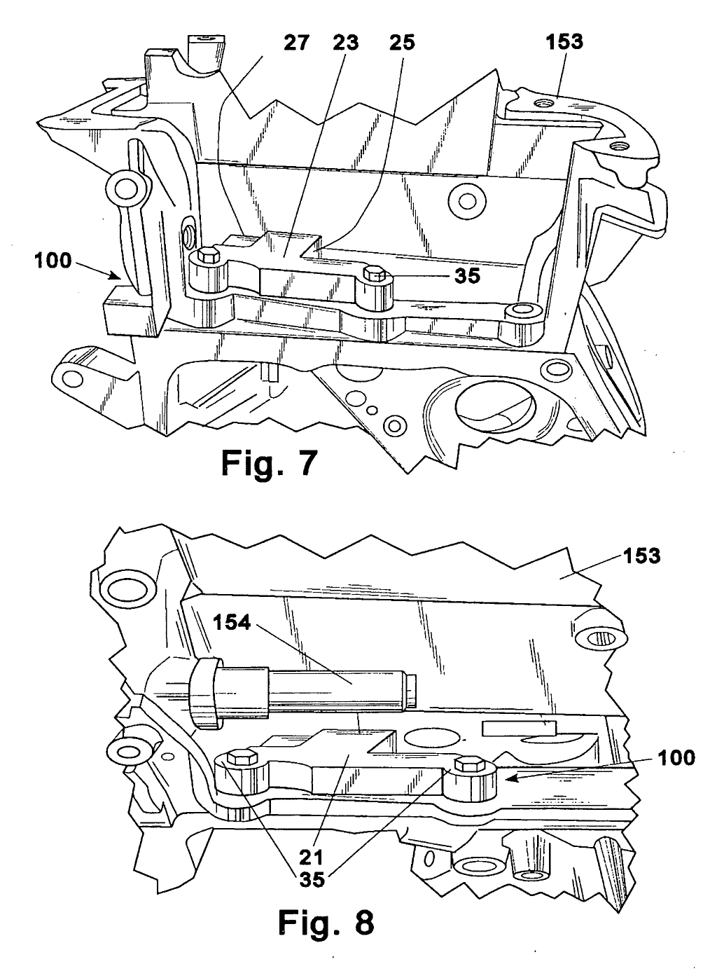

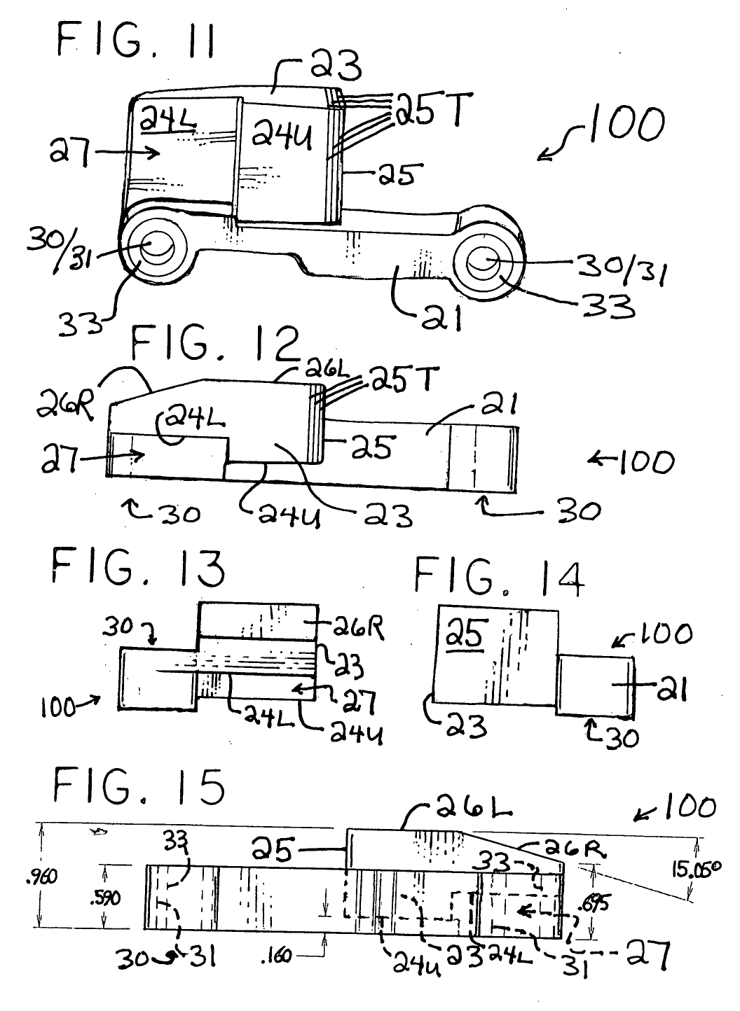

FIG. 7 is a front perspective view of an anti-backlash device of FIG. 1 installed in a Chrysler 2.7-liter V-6 DOHC engine, with the upper right hand side timing chain cover, chain-tensioner, timing chain, and timing chain guide of the engine removed. The devices of FIGS. 4 and 11 can be correspondingly installed.

FIG. 8 is a top perspective view of the anti-backlash device installed as in FIG. 7, except that the engine has its chain-tensioner installed.

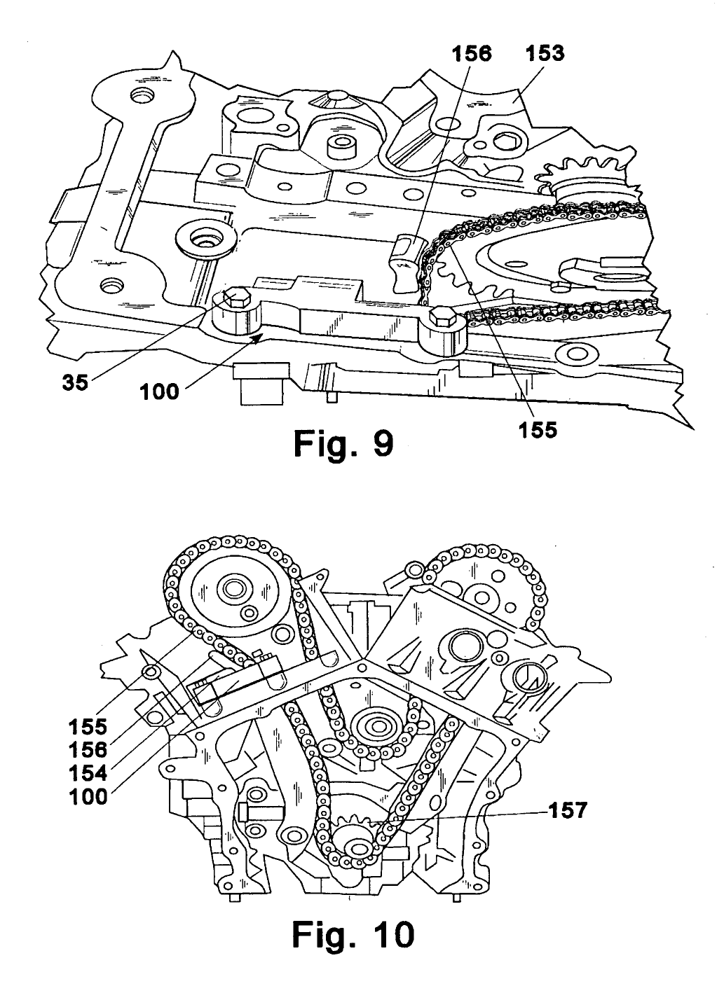

FIG. 9 is a top perspective view of the anti-backlash device installed as in FIG. 7, except that the engine has its timing chain and timing chain guide installed.

FIG. 10 is a front view of the anti-backlash device installed as in FIG. 7, except that the engine also has its lower central timing chain cover removed, and the engine has its chain-tensioner, timing chain, and timing chain guide installed.

FIG. 11 is a top perspective view of another embodiment of an anti-backlash device of the invention.

FIG. 12 is a rear inverted view of the embodiment of FIG. 11.

FIG. 13 is a right side inverted view of the embodiment of FIG. 11.

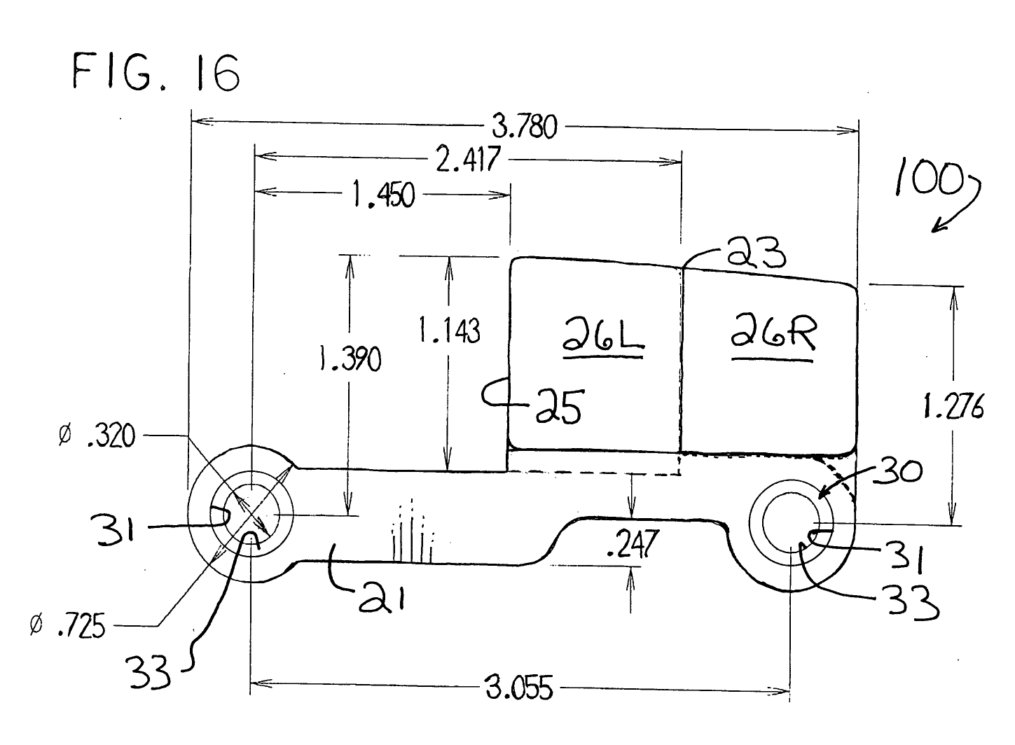

FIG. 14 is a left side inverted view of the embodiment of FIG. 11.

FIG. 15 is a front inverted plan view of the embodiment of FIG. 11.

FIG. 16 is a bottom plan view of the embodiment of FIG. 11.

The invention can be further understood by the detail set out below, which may be read in view of the drawings. Such is to be taken in an illustrative and not necessarily limiting sense.

As mentioned above, an anti-backlash device is provided for an internal combustion engine that has a timing chain. The device includes a body with a stop shoulder to provide a default tension for the chain; and a mounting feature with the body.

The present device can be made of any suitable material(s). Since the device is intended for an internal combustion engine, generally in a compartment enclosing the timing chain to the engine, it is desirable to employ oil—and at least moderately heat-resistant structural material(s). Accordingly, the device or its components can be made of a metal such as aluminum, iron, copper and so forth, and/or synthetic plastics such as nylon, polyurethane, polypropylene, and so forth and the like.

Any suitable method or process can be employed to make the device. For instance, metal or plastic may be machined from stock or molded to provide the device, or a part of the device, say, the body, may be machined, or molded and/or machined, with other components such as a stress encountering part, for example, a part of the mounting feature, press-fit to the body.

With reference to the drawings, anti-backlash device 100 has body 20 molded and/or machined from Nylon 6/6 660 (polyamide 66). The body 20 can include front arm 21 about four inches long and rear protrusion 23 extending rearward about 1¼ to about 1½ inches from a center area or a part of the arm 21, which can have protrusion top surface(s) 24, which may be, for example, stepped with protrusion lower top surface 24L and protrusion upper top surface 24U; chain guide stop shoulder 25, which may include shoulder trimming marks 25T, say, at 0.040-0.050 of an inch, for trimming back to the last mark for a new timing chain in a new engine or a new replacement timing chain in a used engine or for leaving without trimming to any mark for a more stretched timing chain in a used engine or to trim to an intermediate mark for a less stretched chain in a used engine; and protrusion bottom surface(s) 26, which may include protrusion leading bottom surface 26L and protrusion reserve and/or ramped bottom surface 26R. Chain tensioner accommodating recess 27 may be, for example, stepped. A ramped chain tensioner accommodating recess 27R may be provided when the protrusion upper surface 24 is ramped (FIG. 3, in dashed hypothetical line). Mounting feature 30 may include mounting hole(s) 31 in the arm 21, which may be reinforced with aluminum bushing 33, for example, with a 0.500-inch outside diameter and a 0.320-inch inside diameter. The device 100 can be injection molded and lubricated-temperature rated DTUL @ 66-psi-unannealed-410-degree Fahrenheit test method (ASTM D 648) with the aluminum bushings 33 molded integrated with an integral one-piece body 20. Bolt(s) 35 can be employed to mount the device 100 to engine 153; stud(s), clamp(s), welding, gluing and/or press-fitting and so forth may be employed.

Installation of the device 100 can be carried out as follows:
The device 100, for example, may be engineered for all Chrysler engines, say, the engine 153 having tensioner 154 and so forth.
The device 100 can be provided oversized and trimmed to fit by trimming to the appropriate trim mark 25T or leaving as is, as the situation dictates. Trimming may be done for variations in size of timing chain 155 owing to stretching, or installation of new chains and gears.
The device 100 installs directly under the main-primary tensioner 154.
   1. To install, remove the right hand valve cover (viewing from rear of the engine 153) and the tensioner 154.
   2. Pressure is kept on timing chain guide 156 to prevent the timing chain 155 from moving.
   3. Two small front head bolts are removed.
   4. The device 100 is bolted to the head using the two bolts 35, which may be supplied in with the device 100 in a kit.

Compare, FIGS. 7-10.

With the device 100 installed in the engine 153, should the chain-tensioner 154 fail, the device provides a default level of tension for the timing chain 155, which is associated with the timing chain guide 156. With the device 100 so installed, upon failure, the operator may hear a ticking under the hood from the failed tensioner 154, but the tension provided by the device 100 protects the timing chain 155 through the guide 156 from jumping off chain drive sprocket 157, and suitable timing is preserved for enough time for the alert driver to take his vehicle in for replacement of the tensioner 154 so that optimal tensioning of the chain 155 can be restored for normal quiet running.

The kit can include one device 100 and fastener(s), for example, two bolts 35, or more if desired. Additional parts, for example, replacement engine parts, may be provided with the kit. Packaging and/or instructions may be provided with the kit.

Any numerical value recited herein to include in the drawings may be considered to be approximate or exact. Numerical values set forth in the drawings are listed in inches.

### CONCLUSION TO THE INVENTION

The present invention is thus provided. Various feature(s), part(s), step(s), subcombination(s) and/or combination(s) can be employed with or without reference to other feature(s), part(s), step(s), subcombination(s) and/or combination(s) in the practice of the invention, and numerous adaptations and modifications can be effected within the spirit of the invention, the literal claim scope of which is particularly pointed out as follows:

What is claimed is:

1. An anti-backlash device for an internal combustion engine that has a timing chain, which comprises:
a body having a stop shoulder to provide a default tension for the timing chain of the engine; and
a mounting feature with the body.

2. The anti-backlash device of claim 1, wherein the body includes a front arm and a rear protrusion connected with said arm, on which protrusion said stop shoulder resides; and said mounting feature includes mounting hole(s) in said arm.

3. The anti-backlash device of claim 2, wherein:
said arm is elongate and extends about four inches;
said protrusion:
extends rearward about 1¼ to about 1½ inches from a center area or a part of the arm;
has protrusion top surface(s);
has protrusion bottom surface(s); and
provides for a chain tensioner accommodating recess;
said mounting feature includes two mounting holes, each on an opposing end of said arm, with said center area or part of the arm defining the rearward extension of said protrusion being defined by a line between centers of said two mounting holes; and
said stop shoulder is present a distance approximately half that of the line between centers of said two mounting holes but rearward of said line.

4. The anti-backlash device of claim 3, wherein the protrusion top surface(s) embrace a protrusion lower top surface and a protrusion upper top surface so that the chain tensioner accommodating recess is stepped.

5. The anti-backlash device of claim 3, wherein shoulder trimming marks are provided in conjunction with said stop shoulder.

6. The anti-backlash device of claim 4, wherein shoulder trimming marks are provided in conjunction with said stop shoulder.

7. The anti-backlash device of claim 6, wherein the protrusion bottom surface(s) embrace a protrusion leading bottom surface and a protrusion reserve and/or ramped bottom surface.

8. The anti-backlash device of claim 1, wherein said engine is a Chrysler V-6 2.7-liter DOHC engine.

9. The anti-backlash device of claim 3, wherein said engine is a Chrysler V-6 2.7-liter DOHC engine.

10. In combination, the anti-backlash device of claim 1 and the internal combustion engine that has a timing chain, wherein said device is mounted by said mounting feature to said engine such that the stop shoulder of said device can provide a default tension for the timing chain of the engine.

11. In combination, the anti-backlash device of claim 3 and the internal combustion engine that has a timing chain, wherein said device is mounted by said mounting feature to said engine such that the stop shoulder of said device can provide a default tension for the timing chain of the engine.

12. In combination, the anti-backlash device of claim 8 and the internal combustion engine that has a timing chain, wherein said device is mounted by said mounting feature to said engine such that the stop shoulder of said device can provide a default tension for the timing chain of the engine.

13. In combination, the anti-backlash device of claim 9 and the internal combustion engine that has a timing chain, wherein said device is mounted by said mounting feature to said engine such that the stop shoulder of said device can provide a default tension for the timing chain of the engine.

14. A kit for reducing or avoiding backlash in a timing chain in an internal combustion engine, which comprises:
an anti-backlash device for an internal combustion engine that has a timing chain, which embraces:
a body having a stop shoulder to provide a default tension for the timing chain of the engine; and
a mounting feature with the body; and
at least one fastener for engaging said device by the mounting feature, and for mounting said device to said engine.

15. The kit of claim 14, wherein the body includes a front arm and a rear protrusion connected with said arm, on which protrusion said stop shoulder resides; said mounting feature includes two mounting holes, each on an opposing end of said arm; and said at least one fastener embraces at least two bolts.

16. The kit of claim 15, wherein:
said arm is elongate and extends about four inches;
said protrusion:
extends rearward about 1¼ to about 1½ inches from a center area or a part of the arm defined by a line between centers of said two mounting holes;
has protrusion top surface(s);
has protrusion bottom surface(s); and
provides for a chain tensioner accommodating recess; and
said stop shoulder is present a distance approximately half that of the line between centers of said two mounting holes but rearward of said line.

17. A method of reducing or avoiding backlash in a timing chain in an internal combustion engine, which comprises:
providing an anti-backlash device for an internal combustion engine that has a timing chain, which embraces:
a body having a stop shoulder to provide a default tension for the timing chain of the engine; and
a mounting feature with the body; and
installing said device in the engine by mounting it to the engine by said mounting feature.

18. The method of claim 17, further comprising:
providing at least one fastener for engaging said device by said mounting feature; and
mounting said device to said engine by engaging said device by the mounting feature with said at least one fastener.

19. The method of claim 17, further comprising running said engine with said device installed.

20. The method of claim 18, further comprising running said engine with said device installed.
